(19) United States
(12) Patent Application Publication
(10) Pub. No.: US 2026/0130383 A1
(43) Pub. Date: May 14, 2026

(54) DEVICE FOR PRODUCING A BALL-SHAPED FOOD PRODUCT

(71) Applicant: Albert Handtmann Maschinenfabrik GmbH & Co. KG, Biberach (DE)

(72) Inventor: Mark MARRINK, Laren (NL)

(21) Appl. No.: 19/388,833

(22) Filed: Nov. 13, 2025

(30) Foreign Application Priority Data
Nov. 13, 2024 (EP) 24212680.3

(51) Int. Cl. A22C 7/00

(52) U.S. Cl. CPC A22C 7/0015

(57) ABSTRACT

The disclosure relates to a device and a method for producing a ball-shaped food product, in particular burger patty, with a conveyor belt for conveying a strand of food, in particular a strand of ground meat, in the direction of transport and with a forming device for forming the ball-shaped food product and having oppositely disposed forming members that can be moved on the conveyor belt transverse to the direction of transport toward one another to a forming position and can be moved apart. The forming device further comprises a die that can be moved up and down and that, in a forming position, can be moved between the forming member. The underside of the die and the sides of the forming members facing the center of the conveyor belt each have inwardly facing curved recesses.

### CROSS REFERENCE TO RELATED APPLICATION

The present application claims priority to European Patent Application No. 24212680.3 filed on Nov. 13, 2024. The entire contents of the above-listed application are hereby incorporated by reference for all purposes.

### TECHNICAL FIELD

The disclosure relates to a device and a method for producing a ball-shaped food product, for example a burger patty, as well as to a filling machine with a corresponding device.

### BACKGROUND

Ball-shaped or substantially spherical food products made from various foodstuffs are well known in the art. In particular, so-called “smashed burgers” are produced from meatballs which are then placed on the grill and flattened. FIG. 6 shows, on the left-hand side, a ball-shaped burger patty which is made from ground meat which is produced by a meat grinder and in which the structure of the individual strands is maintained, and, on the right-hand side, a ball-shaped burger patty formed from meat dough.

### SUMMARY

Prior art provides many different ways of producing food balls or meatballs, respectively. The known devices are complicated and, in the framework of burger patties, all have the disadvantage that the ball-shaped burger patties no longer have the individual strands produced in the meat grinder, resulting in a different appearance.

To date, ball-shaped burger patties have therefore been formed primarily by hand. The ground meat produced by the meat grinder must be carefully formed into a ball so that the structure of the individual strands is not destroyed, as shown, for example, in FIG. 7. The ball-shaped burger patty can then be placed on the grill and pressed flat, retaining its attractive original shape.

Ball-shaped food products are not only of interest for ground meat but also for various veggie products, etc.

Starting out from there, the present disclosure is based on the object of providing an improved device for producing a substantially ball-shaped food product and a corresponding method that can produce ball-shaped food products in a simple manner, in particular ball-shaped burger patties.

According to the disclosure, this object is satisfied by the features described herein.

Ball-shaped food products are understood to be a ball that is made from the food product and does not necessarily have to be perfectly spherical, but the height of which, for example, does not deviate by more than 30% from its maximum diameter and which, when resting on a substrate, has a rounded, free outer contour. The device comprises a conveyor belt for conveying a strand of food, for example a strand of ground meat, produced, for example, by a meat grinder, onto the conveyor belt. The conveyor belt conveys the strand of food in direction of transport T.

Furthermore, the device comprises a forming device for forming the ball-shaped food product while it is disposed on the conveyor belt. The forming device comprises forming members that are disposed oppositely relative to the strand of food and that can be moved toward one another on the conveyor belt to a forming position and then moved apart again. This means that the forming members are configured to be movable, for example, transverse to direction of transport T. In some examples the forming members may be configured to be moveable in a direction perpendicular to the direction of transport T. The forming device further comprises a die that can be moved up and down and that, in a forming position, can be moved between the forming members such that, in the forming position, the strand of food is compressed and shaped by the forming members and the die.

To enable the formation of ball-shaped food products, the underside of the die and the sides of the forming members facing the center of the conveyor belt each have inwardly facing curved recesses. These curvatures allow for the rounded outer contour to be created. The recess in the die is configured to produce a rounded upper dome of the ball-shaped food product.

This means that the forming device forms the food product by way of the forming members, the die, and the conveyor belt on which the forming members are arranged. The conveyor belt is indeed straight and not rounded, but this is not a problem because the ball-shaped food product will later rest on its lower surface, e.g., in the package, on a grill, in a pot or pan, etc., and the product will still have a perfectly ball-shaped or spherical appearance, respectively.

The device can therefore easily form the respective food balls, where, in particular with ground meat, the original structure created by the meat grinder-i.e., the strands pushed out from the meat grinder-can retain their shape.

It is advantageous to have the curved recesses of the die and the forming members be adjacent to one another in the forming position such that a closed forming space is created on the conveyor belt and has a shape that is complementary to the ball-shaped food product.

Advantageously, the recess in the respective forming member is configured such that the inner wall of the respective forming member is curved when viewed in cross-section, in particular formed as a partial circle or semicircular. The respective forming member can then each enclose a lateral half of the food product. In this application, cross-section is to mean cross-sectional cutting planes parallel to the conveyor belt.

Advantageously, the cross-sectional area of the respective recess decreases downwardly at least in sections, at least in a lower region, for example in a lower half of the respective forming member. This means that the food product also has a larger diameter in the center region than in the lower region so that a ball shape or spherical shape can be created. “At least in sections” means that the cross-sectional area does not have to decrease continuously or steadily, but also step-wise.

Advantageously, the inner surface is curved when viewed in a cross-sectional view at least in a lower region, in particular in the lower half of the respective forming member, and, at the same time, is curved when viewed in longitudinal sectional view transverse to the direction of transport T.

It is advantageous to have the recess of the die be substantially circular when viewed in a cross-sectional view, i.e., it has a circular outer contour. This allows the dome of the ball-shaped food product to be created. It is particularly advantageous to have the recess be curved such that the cross-sectional area of the recess in the die increases toward the underside of the die.

It is advantageous to have the forming members be arranged in the forming position such that oppositely disposed side regions of the forming members touch each other. This means that each forming member has a front side region and a rear side region, when viewed in the direction of transport, between which the recess is arranged. When the oppositely disposed side regions of the oppositely disposed forming members touch each other, the forming space can be closed, and in addition to the forming, the ball-shaped food product can be separated or severed from the strand of food at the same time.

According to a further embodiment, the oppositely disposed forming members have respective cutting edges whose cutting surfaces overlap when the forming members are arranged in the forming position. This means that each forming member has a front cutting edge and a rear cutting edge, when viewed in the direction of transport, between which the recess is arranged. If the oppositely disposed cutting surfaces of the oppositely disposed forming members overlap and touch, the forming space can be closed, and in addition to the forming, the ball-shaped food product can be cut from the strand of food in an improved manner at the same time.

When viewed in a direction transverse to the direction of transport and in the direction of transport, it is advantageous to have the distance between the inner surfaces of the oppositely disposed forming members decrease downwardly in the lower half and be optionally substantially uniform in an upper region of the forming members, for example in an upper half of the forming members. A rounded outer contour can thus be created in the lower region, for example in the lower half, while the rounded shape of the ball-shaped food product in the upper region can be created by the die. If the distance between the side surfaces of the oppositely disposed forming members is uniform in the upper region, then the upper region of the forming members can be used as a guide for the die.

This means that the die can advantageously be guided in the upper region of the forming members over the inner surfaces of the forming members, where the outer contour of the die is optionally configured to be substantially complementary to the inner contour of the oppositely disposed forming members when the latter are in the forming position. The die is then optionally inserted to a maximum of half the height of the forming members.

In the method according to the disclosure for producing a ball-shaped food product, a strand of food is produced and applied to the conveyor belt. The strand of food is transported on the conveyor belt between the forming members spaced from one another. The forming device is then closed. This is done by moving the forming members toward one another to the forming position, thereby displacing the food. By moving the die from above onto the strand of food, the food is pressed to take a ball-like shape by the forming members, the die, and the conveyor belt. The forming device is thereafter opened and the ball-shaped food product can be, for example, conveyed onward or removed from the conveyor belt and, for example, be packaged.

Advantageously, the forming device is held in the forming position for a specific time before opening, in particular 300 ms to 1000 ms. This allows the individual components of the food to adhere to one another, for example, the individual strands of ground meat, so that the ball-shaped food product is subsequently dimensionally stable.

Optionally, the food product is ground meat, where ground meat, optionally formed from a plurality of individual strands, is produced onto the conveyor belt by a meat grinder. Ball-shaped burger patties are produced by way of the forming device and can then be placed, for example, onto the grill and flattened by the consumer.

The disclosure also relates to a filling machine with a device having a conveyor mechanism that produces the food onto the conveyor belt via an outlet device, e.g., an outlet pipe. The ball-shaped food product can then be produced in-line. Optionally, the outlet device comprises a meat grinder for producing the ground meat directly onto the conveyor belt.

### BRIEF DESCRIPTION OF THE FIGURES

The present disclosure shall be explained hereafter in more detail with reference to the following figures.

FIG. 1 shows in a simplified schematic illustration an embodiment of a filling machine according to the present disclosure.

FIG. 2 shows a schematic perspective view of a forming device ad well as produced ball-shaped burger patties in a tray.

FIG. 3 shows a schematic longitudinal sectional view transverse to the direction of transport of an embodiment of a forming device according to the present disclosure.

FIG. 4A shows a longitudinal sectional view through the central axis M of the embodiment shown in FIG. 3 in the direction of transport with the die being open.

FIG. 4B shows a longitudinal sectional view of the embodiment shown in FIG. 3 in the direction of transport T through the central axis M along the line I-I.

FIG. 4C shows a cross-sectional view along the line II-II in FIG. 3.

FIG. 4D shows a cross-sectional view along the line III-III in FIG. 3.

FIG. 4E shows a cross-sectional view along the line IV-IV in FIG. 3.

FIG. 4F shows a bottom view of the base in FIG. 3.

FIGS. 5A-5D show the method sequence according to an embodiment of the present disclosure.

FIG. 6 shows two differently shaped ball-shaped burger patties.

FIG. 7 shows in a simplified schematic illustration a meat grinder as well as ground meat which is produced by the meat grinder and which is formed from a plurality of individual strands.

FIG. 8 shows a cross-section of the cutting edges of the forming members in the forming position according to a preferred embodiment.

### DETAILED DESCRIPTION

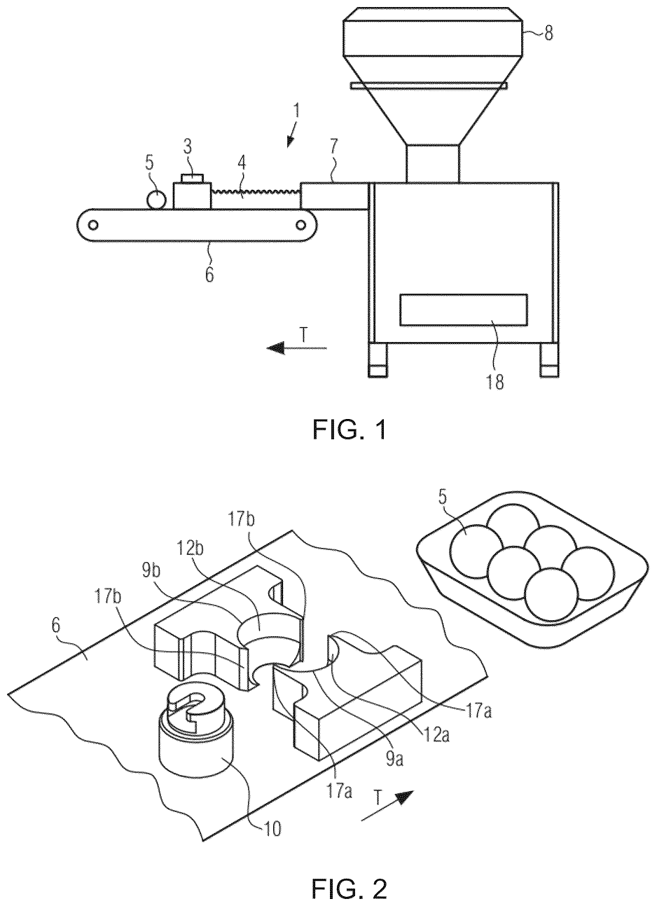

FIG. 1 shows an embodiment of a filling machine 2 with a device 1 according to the disclosure for producing a ball-shaped food product 5 from a strand of food 4.

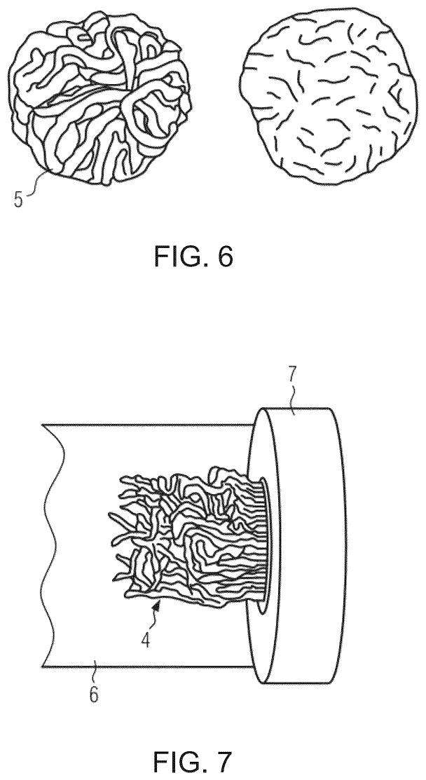

The filling machine is known to comprise a hopper 8 as well as a conveyor mechanism (not shown), such as a rotary vane pump, by way of which the food product, for example, meat or a veggie mixture, can be produced as a strand of food 4 onto a conveyor belt 6 to an outlet device, for example, a filling tube, and conveyed in direction of transport T. Optionally, for example, the outlet device comprises a meat grinder 7, by way of which ground meat can be produced, as shown in particular in FIG. 7, for example in the form of a plurality of individual strands.

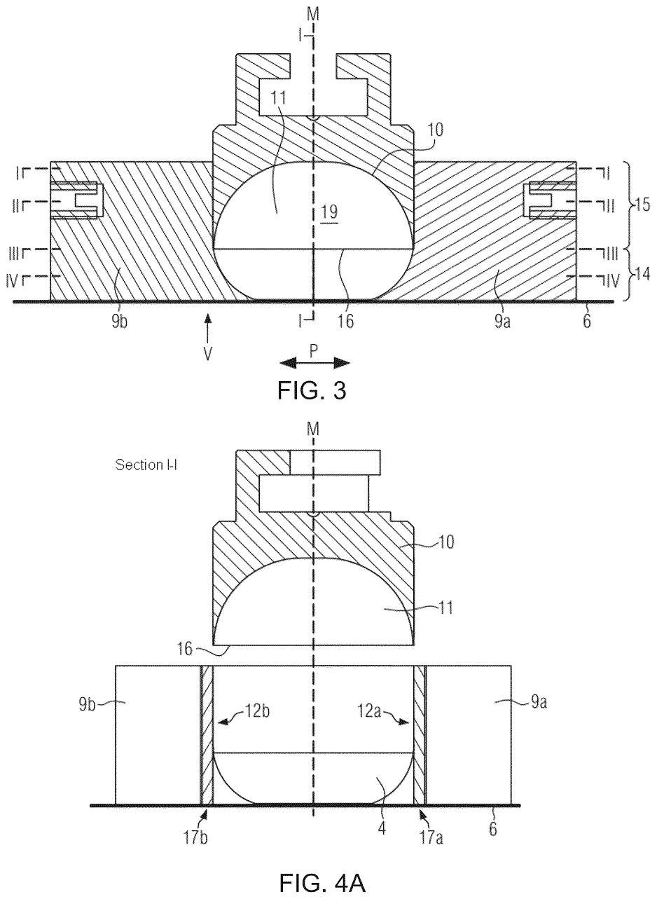

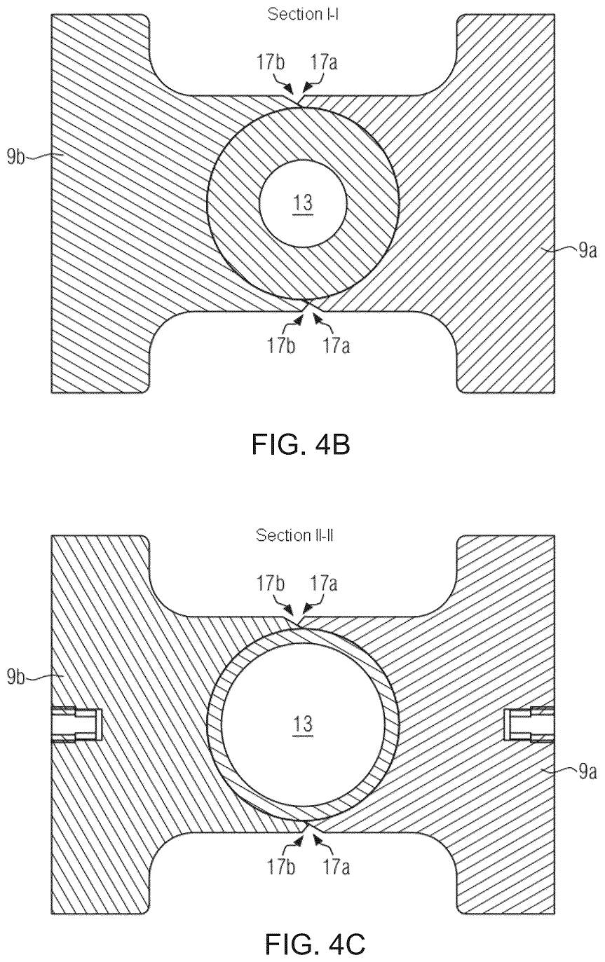

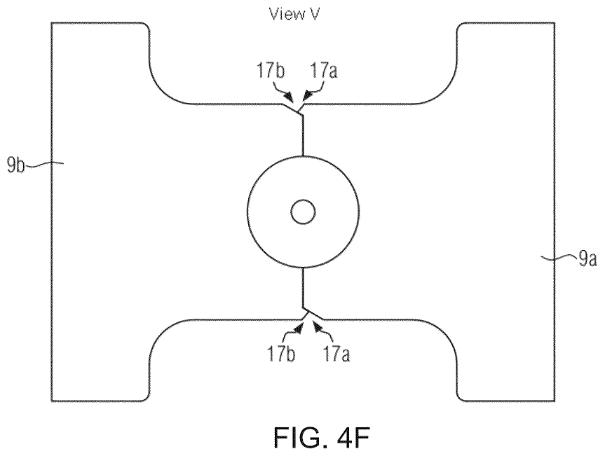

Device 1 for producing ball-shaped food product 5, for example, in the case of ground meat for a burger patty 5, comprises oppositely disposed forming members 9a, 9b, as can be gathered, in particular, from FIGS. 2 to 4E. These forming members are arranged such that, in a forming position F, they can be moved toward one another on conveyor belt 6 transverse to direction of transport T and can also be moved apart again. Forming members 9a, 9b are arranged laterally of strand of food 4 and can engage with strand of food 4 during their movement to forming position F. Forming device 3 also comprises a die 10 that, in a forming position F, can be moved between forming members 9a, 9b such that strand of food 4 in forming position F can be formed by forming members 9a, 9b, die 10, and conveyor belt 6, as can be gathered in particular from FIG. 3 and FIGS. 5A-5D, which shall be described in more detail below.

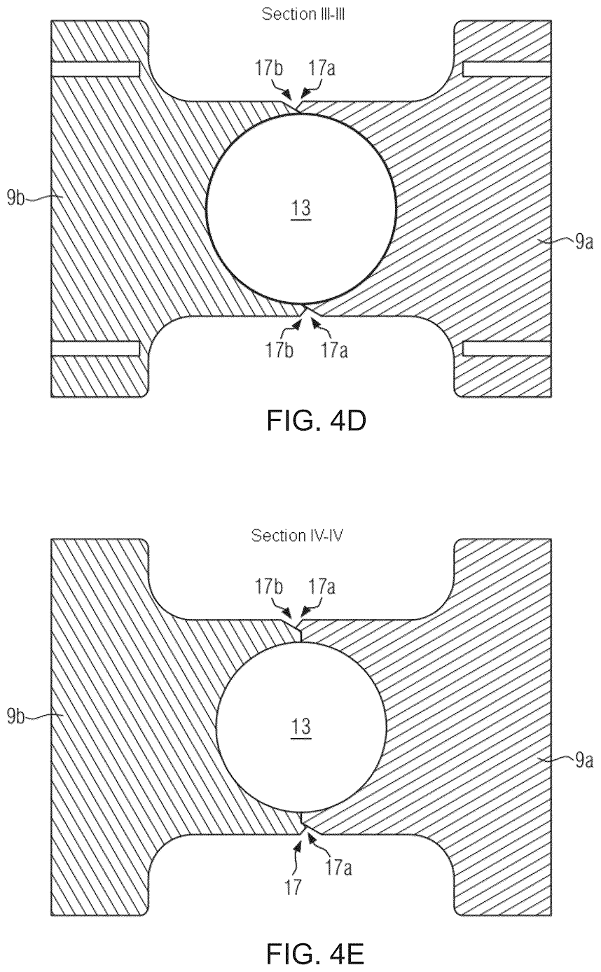

According to the disclosure, underside 16 of die 10 has a curved recess 11 that faces inwardly, i.e., into the die. The recess is configured such that a rounded upper dome of the ball-shaped food product can be created. FIG. 3 schematically shows a longitudinal sectional view transverse to direction of transport T of an embodiment of a forming device according to the disclosure with the die being closed. FIG. 4A shows a longitudinal sectional view through central axis M of the embodiment shown in FIG. 3 in direction of transport T with die 10 being open. Central axis M is located at the center of forming device 3 and is perpendicular to the conveyor belt.

FIG. 4B shows a cross-sectional view along the line I-I in FIG. 3. Like the cross-section, presently in a plane parallel to the conveyor belt, shows, recess 11 in die 10 has a substantially circular shape.

FIG. 4C shows a section along line II-II, i.e., below section line I-I in FIG. 3. Recess 11 has a larger diameter than in FIG. 4B.

FIG. 4D shows a cross-sectional view along line III-III in FIG. 3, i.e., below the section lines I-I and II-II. In this region, the cross-sectional area of recess 11 in die 10 has a larger cross-section. This means that the cross-sectional area of the recess in the die increases toward underside 16. The shape of the recess can also be seen in FIG. 4A. Optionally, the recess is rotationally symmetrical to central axis M.

Die 10 can be moved up and down by an actuator (not shown), for example, a motor. Two oppositely disposed forming members 9a, 9b can also be moved back and forth by a corresponding actuator, as indicated by arrow P in FIG. 3.

Like die 10, forming members 9a, 9b each have inwardly facing curved recesses 12a, 12b in order to impart a rounded shape upon the food product.

FIG. 4E shows a cross section along line IV-IV of FIG. 3. FIG. 4F shows a bottom view V of FIG. 3. As shown in FIGS. 4A, 4E, and 4F, respective recesses 12a and 12b in respective forming member 9a, 9b are formed such that the inner wall of the respective forming member is curved when viewed in cross-section and is, for example, a partial circle or semicircular. The recess is configured, for example, such that the respective forming member can enclose a lateral half of the food product. However, the inner wall of forming members 9a, 9b is not curved only in this plane, but, as can be gathered from FIGS. 3 and 4A, also in lower part 14, i.e., for example, the lower half of the respective forming member, in order to create the ball-like shape. This curvature extends such that the cross-sectional area of recess 12a, 12b decreases downwardly, i.e., tapers, at least in sections, at least in a lower region 14, for example a lower half of the respective forming member.

Oppositely disposed side regions 17a, 17b of forming members 9a, 9b touch each other when the forming members are arranged in forming position F, i.e., the corresponding oppositely disposed side regions of the oppositely disposed forming members are moved to abutment to laterally close the form. As explained in more detail below and illustrated in the figures, the forming members in this exemplary embodiment have, for example, cutting edges 17a, 17b with corresponding cutting surfaces 20a, 20b.

As can be gathered in particular from FIG. 3 and FIGS. 4A-4F, the distance between the inner surfaces of the oppositely disposed forming members in a direction transverse to the direction of transport is such that it decreases downwardly to create the curved shape. In an upper half 15, the distance between the inner surfaces can be substantially uniform. Therefore, die 10, whose outer contour is formed to be substantially complementary to the inner contour of the oppositely disposed closed forming members in upper region 15, can be guided to the correct position by forming members 9a, 9b. Curved recesses 11, 12a, 12b of die 10 and forming members 9a, 9b in forming position F adjoin one another, as can be gathered, in particular, from FIG. 3, in such a way that a closed and ball-shaped forming space 13 is created on conveyor belt 6 and is optionally formed to be rotationally symmetrical to central axis M. This means that forming device 3 forms food product 5 by way of forming members 9a, 9b, die 10, and conveyor belt 6. The conveyor belt is indeed straight and not rounded, but this is not a problem because the ball-shaped food product created will later rest on its lower surface, e.g., in a package, on a grill, in a pot or pan, etc., and the product can then nevertheless have a ball-shaped or spherical appearance, respectively.

The method according to the disclosure for producing a ball-shaped food product 5 shall be explained in more detail with reference to FIGS. 5A-5D.

A strand of food 4 is first produced, for example, using the filling machine shown in FIG. 1, and applied onto conveyor belt 6 and moved in direction of transport T. The strand of food reaches a position between open forming members 9a, 9b, as shown in FIG. 5A.

Now, for example, during intermittent operation, conveyor belt 6 can briefly stop. For example, control device 18 of filling machine 2 then sends a corresponding control signal to the respective actuator, which in the step shown in FIG. 5B moves forming members 9a, 9b from position A shown in FIG. 5A inwardly into strand of food 4 to a forming position F. The lateral outer regions, or presently cutting edges 17a, b of forming members 9a, 9b, are in abutment, so that lower region 14 completely encloses the food.

As can be gathered from FIG. 5C, control device 18 can then output a corresponding signal and control an actuator such that die 10 moves downwardly. It can be guided by the inner contour of two forming members 9a, 9b. The die can be moved either by travel or force control in any case up to a maximum position in which the diameter between the closed forming members 9a, 9b is not yet smaller than the diameter of the die. FIG. 5C now shows all components 9a, 9b, 10 of forming device 3 in forming position F. Die 10 there presses onto the food product that is enclosed by the forming members and the conveyor belt. Curved recesses 11, 12a, 12b of die 10 and forming members 9a, 9b adjoin one another in such a way that a closed and ball-shaped forming space 13 is created on conveyor belt 6.

The forming position shown in FIG. 5C is then held for 300 ms to 1000 ms to ensure that secure bondage of the food is created and that the product does not subsequently disintegrate.

Subsequently, as can be gathered from FIG. 5D, the actuators for forming members 9a, 9b and die 10 are controlled, for example, by controller 18, such that forming members 9a, 9b move apart outwardly again and the die moves upwardly in order to thus release ball-shaped food product 5. Resulting ball-shaped food product 5 can then be transported onward on conveyor belt 6 or be removed, and, as can be gathered from FIG. 2, for example, several ball-shaped food products 5 can be packed into a tray.

After the step shown in FIG. 5D, conveyor belt 6 is moved onward, for example, by one section, so that the next food product 5 can then be formed in the adjoining strand of food. Although not shown, it is possible during continuous operation that forming device 3 moves in the closed state together with conveyor belt 6 in transport direction T. It is also possible for forming device 3 to have several forming members 9a, 9b that are arranged one behind the other in direction of transport T and that adjoin one another through edges 17a, 17b, in order to simultaneously form several ball-shaped food products in strand of food 4.

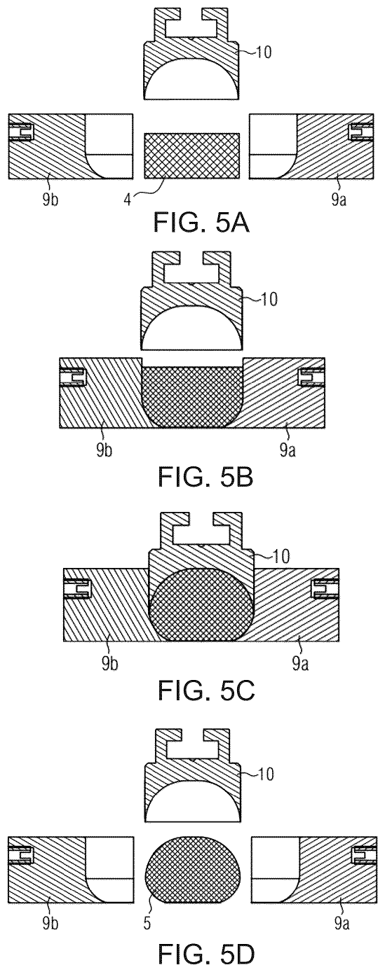

According to an embodiment, the food product is ground meat, which is produced by a meat grinder 7, as illustrated in FIGS. 1 and 7, and which is formed in particular from a plurality of individual strands. This ground meat is produced as a product strand 4 onto conveyor belt 6. Using the aforementioned method according to the disclosure with the aid of the device previously explained, a ball-shaped burger patty can be produced that still has the respective structures of the ground meat produced, i.e., in which the individual strands remain recognizable in the product, as shown in FIG. 6, left-hand illustration. In summary, it can be stated that a ball-shaped food product can be manufactured in a simple manner by the curved recesses of the forming members and the die adjoining one another as well as the conveyor belt adjoining thereto.

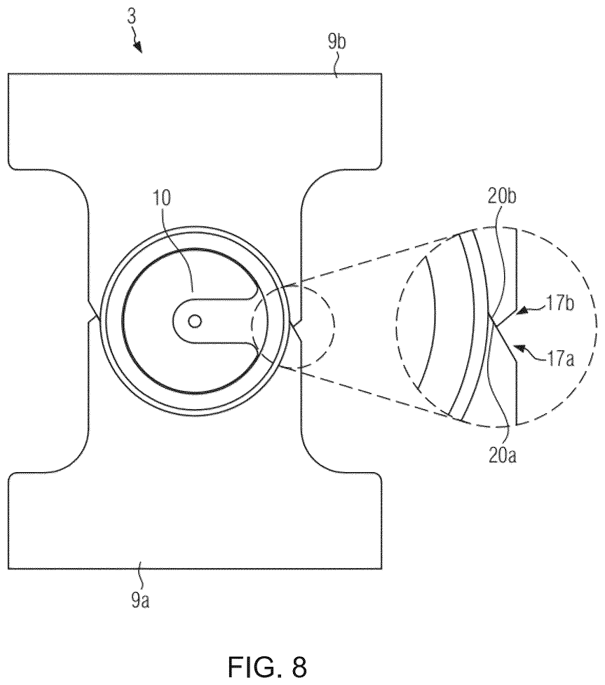

According to an embodiment, oppositely disposed forming members 9a, 9b have respective cutting edges 17a, 17b whose cutting surfaces 20a, 20b overlap when the forming members are arranged in forming position F, as can be gathered from the enlarged illustration in FIG. 8. This means that each forming member 9a, 9b comprises a front cutting edge and a rear cutting edge 17a, 17b, when viewed in the direction of transport, between which recess 12a, 12b is arranged.

When the cutting surfaces of oppositely disposed cutting edges 17a and 17b of the oppositely disposed forming members are moved towards each other until they touch in an overlapping manner, the forming space can be closed laterally and, in addition to the forming process, the ball-shaped food product can be sheared off at the same time from the strand of food.

1. A device for producing a ball-shaped food product, comprising:
a conveyor belt for conveying a strand of food in a direction of transport, and
a forming device for forming said ball-shaped food product comprising oppositely disposed forming members that can be moved toward one another on said conveyor belt transverse to the direction of transport to a forming position and can be moved apart, and a die that can be moved up and down and that, in the forming position, can be moved between said forming members,
wherein the underside of said die and the sides of said forming members facing the center of said conveyor belt each have inwardly facing curved recesses.

2. The device according to claim 1, wherein said curved recesses of said die and said forming members adjoin one another in said forming position such that a closed ball-shaped forming space is formed on said conveyor belt.

3. The device according to claim 1, wherein said recess in respective forming member is formed such that the inner wall of said respective forming member is curved when viewed in cross-section.

4. The device according to claim 3, wherein the cross-sectional area of said recess decreases downwardly when viewed in cross-section, at least in sections, at least in a lower region.

5. The device according to claim 1, wherein the inner surface is curved when viewed in cross-section at least in a lower region, and, at the same time, is curved when viewed in longitudinal section transverse to the direction of transport.

6. The device according to claim 1, wherein said recess in said die is substantially circular when viewed in cross-section.

7. The device according to claim 1, wherein the cross-sectional area of said recess in said die increases toward said underside.

8. The device according to claim 1, wherein, when said forming members are arranged in said forming position, oppositely disposed side regions of said oppositely disposed forming members touch each other, or
said oppositely disposed forming members have respective cutting edges whose cutting surfaces overlap when said forming members are arranged in the forming position.

9. The device according to claim 8, wherein the distance between the inner surfaces of said oppositely disposed forming members, when viewed in a direction transverse to the direction of transport and in the direction of transport, decreases downwardly in a lower region, and is substantially uniform in an upper region of said forming members.

10. The device according to claim 9, wherein said die can be guided in the upper region of said forming members over the inner surfaces of said forming members, wherein the outer contour of said die is configured to be substantially complementary to the inner contour of said oppositely disposed forming members when the latter are in the forming position.

11. A method for producing a ball-shaped food product with the device according claim 1, with the following steps:
producing a strand of food and applying said strand of food onto said conveyor belt,
transporting said strand of food on said conveyor belt between said forming members spaced from one another,
closing said forming device by moving said forming members toward each other to the forming position, thereby displacing the food product, and moving said die from above onto said food product, whereby said food product is pressed to take a ball-like shape by said forming members, said die, and said conveyor belt, and
opening said forming device.

12. The method according to claim 11, wherein said forming device is held in the forming position for a specific time before opening.

13. The method according to claim 11, wherein said food product is ground meat, wherein ground meat is produced onto said conveyor belt by a meat grinder and ball-shaped burger patties are produced by said forming device.

14. A filling machine with the device according to claim 1 and with a conveyor mechanism that produces the food onto said conveyor belt via an outlet device.

15. The filling machine according to claim 14, wherein said outlet device comprises a meat grinder.

16. The device according to claim 1, wherein the ball-shaped food product is burger patties.

17. The device according to claim 1, wherein the strand of food is a strand of ground meat.

18. The device according to claim 3, wherein the inner wall of said respective forming member is a partial circle or semicircular.

19. The device according to claim 4, wherein the lower region is a lower half of said respective forming member.

20. The device according to claim 5, wherein the lower region is a lower half of said respective forming member.
